(19) United States
(12) Patent Application Publication
(10) Pub. No.: US 2010/0108850 A1
(43) Pub. Date: May 6, 2010

(54) STAND FOR SUPPORTING A TREE

(76) Inventor: Mark Steven Holzapfel, San Jose, CA (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 12/263,324

(22) Filed: Oct. 31, 2008

(51) Int. Cl. A47G 33/12; F16M 13/00

(52) U.S. Cl. 248/523; 47/40.5; 248/528

(57) ABSTRACT

A tree stand for suspending a tree is disclosed. In one illustrative embodiment, the tree stand may include a base for providing stability for the tree stand and a center pole for suspending the tree above the base. The center pole may have a first end, a second end, and a length extending therebetween. The first end of the center pole may be coupled to the base and the second end, which may be coupled to the tree, may be spaced a distance from the base defining an angle between the center pole and the base. In some cases, the center pole may be extendable.

### FIELD

The present disclosure relates generally to stands for supporting a tree.

### BACKGROUND

Many stands for displaying a decorative or Christmas tree are available. Typically, these stands include a wide base to provide stability for the stand, and a structure positioned generally in the center of the base for gripping the lower end of the tree. Such a stand attempts to display the decorative or Christmas tree in a straight and upright orientation. However, in many situations, it may be difficult and/or time consuming to properly orient the decorative or Christmas tree in using these stands due to difficulty in accessing the lower end of the tree as well as compensating for bends, notches and/or other deformities that are commonly found in the lower trunk of such trees. Thus, there is an ongoing need to provide alternative stand structures for displaying a tree.

### SUMMARY

The following summary is provided to facilitate an understanding of some of the innovative features unique to the present disclosure and is not intended to be a full description. A full appreciation of the disclosure can be gained by taking the entire specification, claims, drawings, and abstract as a whole.

The present disclosure relates generally to tree stands. In one illustrative embodiment, a tree stand is provided that suspends a tree from a location that is well above the lower end of the tree such as above the center of gravity of the tree. In some cases, the tree stand may include a base for providing stability for the tree stand and one or more center poles for suspending the tree above the base. The center pole may have a first end, a second end, and a length extending therebetween. The first end of the center pole may be coupled to the base, and the second end may be spaced a distance from the base defining an angle between the center pole and the base. The second end of the center pole may be configured to be coupled to the tree. In some cases, the center pole may be extendable and, in some cases, the tree stand may be collapsible, but this is not required.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION

The invention may be more completely understood in consideration of the following detailed description of various illustrative embodiments of the disclosure in connection with the accompanying drawings, in which:

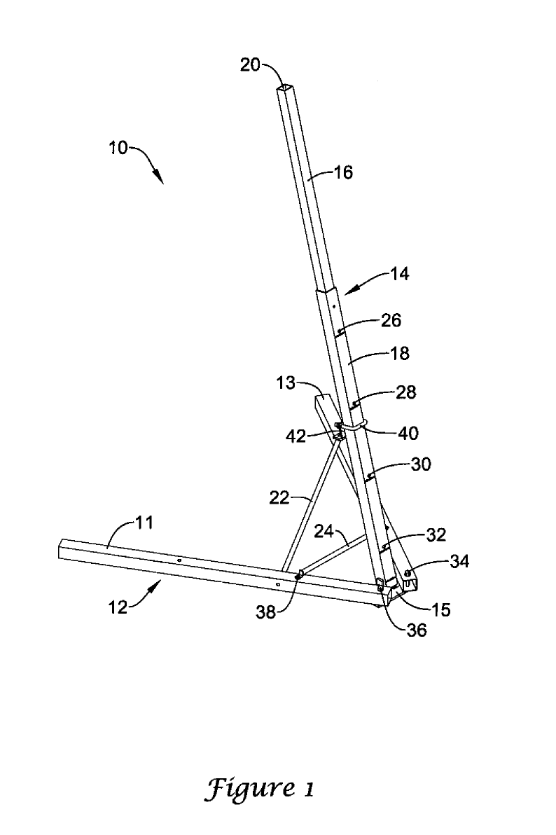

FIG. 1 is a perspective view of an illustrative embodiment of a tree stand;

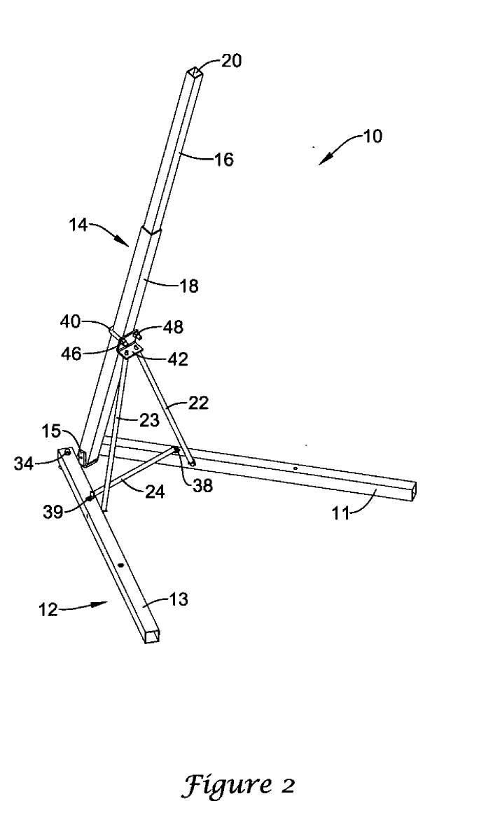

FIG. 2 is another perspective view of the illustrative tree stand of FIG. 1;

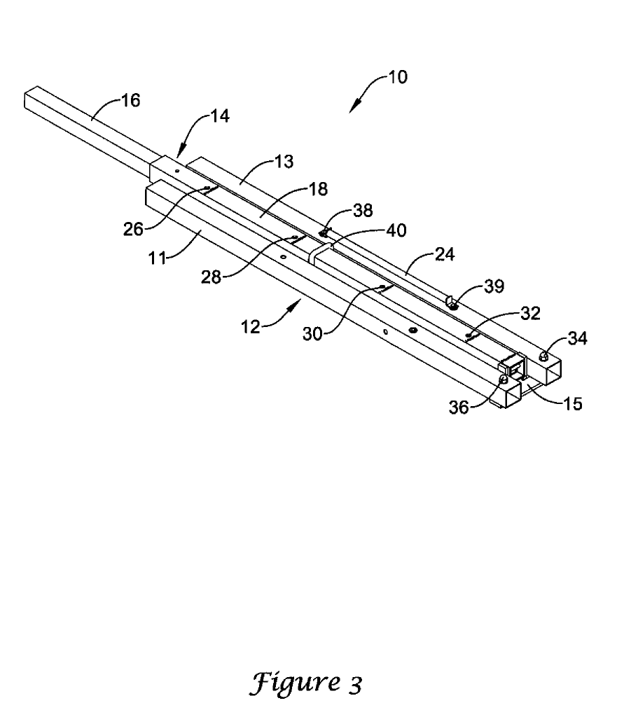

FIG. 3 is a perspective view of the illustrative tree stand of FIG. 1 in a collapsed state;

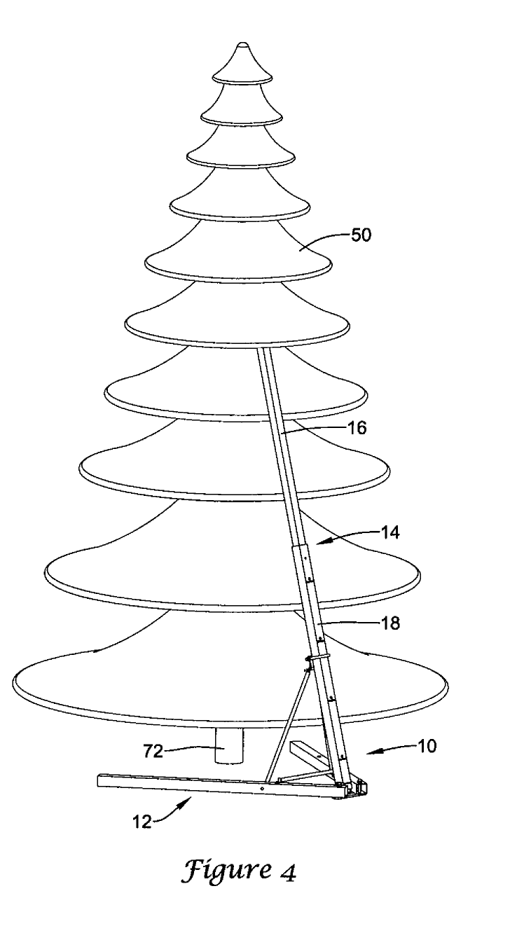

FIG. 4 is a perspective view of the illustrative tree stand of FIG. 1 suspending a tree;

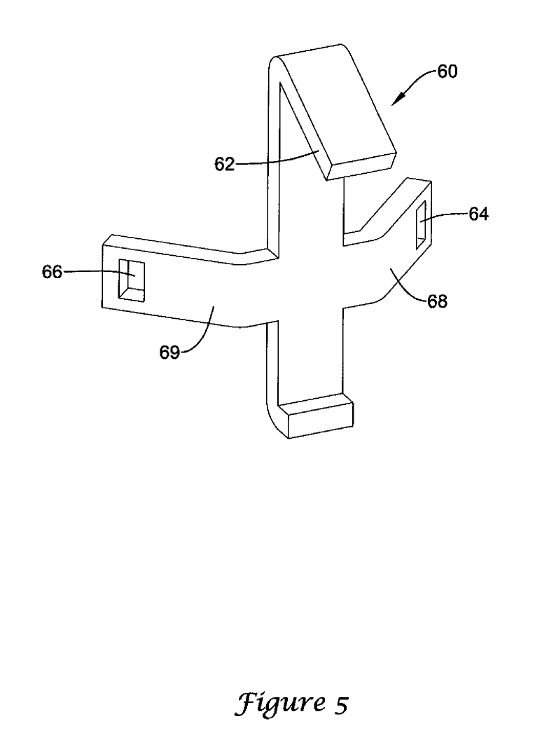

FIG. 5 is a perspective view of an illustrative tree connector configured to engage the illustrative tree stand of FIG. 1;

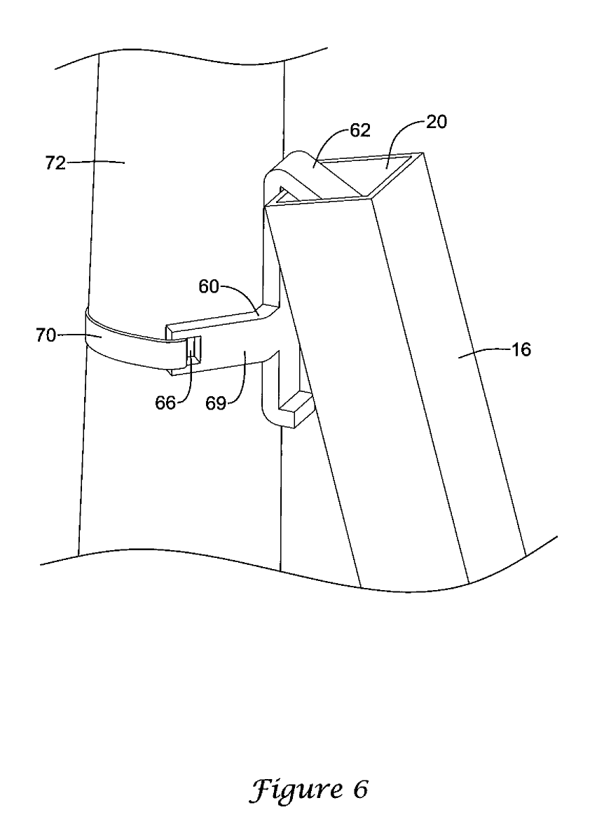

FIG. 6 is a perspective view of the tree connector of FIG. 5 coupled to an illustrative tree trunk; and

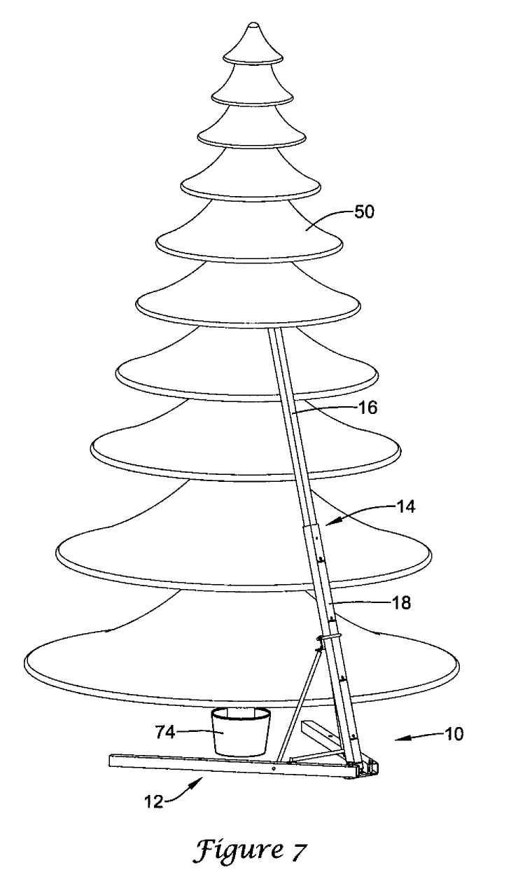

FIG. 7 is a perspective view of the illustrative tree stand of FIG. 1 suspending a tree, similar to FIG. 4, showing a container for watering the tree.

### DETAILED DESCRIPTION

The following description should be read with reference to the drawings wherein like reference numerals indicate like elements throughout the several views. The detailed description and drawings show several embodiments which are meant to be illustrative of the claimed invention.

The following disclosure has be described with reference to relative terms, such as “upwards”, “downwards”, “top”, “bottom”, “up”, “down”, “left”, “right”, as well as other relative terms. It is to be understood that this is merely for simplicity and is not meant to be limiting in any manner.

FIGS. 1 and 2 are perspective views of an illustrative embodiment of a tree stand 10. In the illustrative embodiment, the tree stand 10 may include a base, generally shown at 12, configured to provide stability to the stand 10. The illustrative tree stand 10 also includes a center pole 14 configured to extend a distance upwards from the base 12 to suspend a decorative or Christmas tree from an upper end of the center pole 14. As illustrated, the base 12 may include leg 11 and leg 13. In the illustrative example, one end of leg 11 may be connected to one end of leg 13 via a connector 15 forming a generally v-shaped configuration. Fastener 36 may connect leg 11 to connector 15 and fastener 34 may connect leg 13 to connector 15. In one example, fasteners 34 and 36 may be a screw, bolt, or other fastener as desired. In other example, it is contemplated that the legs 11 and 13 may be welded or otherwise secured to connector 15, or in yet other example, legs 11 and 13 may be welded or otherwise secured directly to each other.

In some embodiments, a support rod 24 may be connected to leg 11 and leg 13 to help maintain the relative position or angle between the legs 11 and 13. To secure support rod 24 to leg 11 and leg 13, fasteners 38 and 39, respectively, may be used. In one example, fastener 38 may be provided through an opening in one end of the support rod 24 and through an opening provided in leg 11. Similarly, fastener 39 may be provided through an opening in one end of the support rod 24 and through an opening provided in leg 13. Similar to the fasteners discussed above, fasteners 38 and 39 may be a screw, bolt, or other fastener as desired. In other example, it is contemplated that the legs 11 and 13 may be welded or otherwise secured to support rod 24.

The foregoing base 12 is merely illustrative and it is contemplated that any suitable base structure may be used, as desired. For example, the base 12 may be a generally planar structure, the base 12 may include more than two legs 11 and 13, and/or the base 12 may be formed in a different shape (e.g. rectangular, square, circle, etc.). These are just a few example alternative structures. Although not shown, it is contemplated that the legs 11 and 13 may be telescopic or extendable, if desired.

As illustrated, the center pole 14 may have a first end connected to the base 12 via connector 15, or in other cases directly, and a second end extending away from the base 12 at an angle. In the illustrative embodiment, the angle between the base 12 and the center pole 14 may be any suitable angle between 0 and 90 degrees, between 45 and 90 degrees, between 50 and 80 degrees, between 60 and 80 degrees, or any other suitable angle or angle range, as desired. In the illustrative embodiment, the center pole 14 may be telescopic or otherwise extendable, but this is not required. When telescopic, the center pole 14 may include an inner pole member 16 and an outer pole member 18 configured to at least partially receive the inner pole member 16. In some cases, the center pole 14 may include a fixed state and a moveable state. In the fixed state, the inner pole member 16 may be fixed relative to the outer pole member 18, as will be discussed in further detail. In the moveable state, the inner pole member 16 may be moveable relative to the outer pole member 18 to adjust the length of the center pole 14.

As illustrated, outer pole member 18 may include a plurality of openings 26, 28, 30, and 32 to assist in adjusting the length of the center pole 14. In some cases, the inner pole member 16 may have a corresponding opening that may be adjusted to align with one of openings 26, 28, 30, and 32. Once the holes are aligned, a pin or other fastener (not shown) may be inserted into the openings of the outer pole member 18 and inner pole member 16 to maintain the alignment. For example, the pin or other fastener may include a bolt, screw, pin, threaded knob, or other fastener, as desired. In other cases, a spring biased button (not shown) may be provided on the inner pole member 16 and as the inner pole member 16 is adjusted relative to the outer pole member 18, the button may protrude through one of openings 26, 28, 30, and 32 to secure the position. A user may depress the button and move the inner pole member 16 relative to the outer pole member 18 to adjust the length of the center pole 14. A tension device such as a threaded knob or spring loaded mechanism may be used to provide unlimited adjustment of inner pole member 16 along the length of outer pole member 18.

In some cases, openings 26, 28, 30, and 32 may correspond to different heights of the center pole 14 or heights of the tree to be suspended. For example, opening 32 may correspond to a tree height of 6 feet, opening 30 may correspond to a tree height of 7 feet, opening 28 may correspond to a tree height of 8 feet, and opening 26 may correspond to a tree height of 9 feet. In some cases, inserting the inner pole member 16 all the way in outer pole member 18 may correspond to a tree height of 5 feet. It will be understood that the foregoing tree heights are merely illustrative and that any suitable heights may be used, as desired.

In some cases, the inner pole 16 and outer pole 18 may be locked together at any relative position by, for example, rotating a collet or the like (not shown) that secures the inner pole relative to the outer pole. Such locking mechanisms are often used on telescoping legs of, for example, tripods used for supporting cameras or the like. This may allow the inner pole 16 to be secured relative to the outer pole 18 at any desired position, resulting in any desired length of the center pole 14.

In some cases, support rods 22 and 23 may be provided to help support the center pole 14 at an angle to the base 12. As illustrated, support rod 22 may have a first end connected to leg 11 and a second end connected to a fastener plate 42. Similarly, support rod 23 may have a first end connected to leg 13 and a second end connected to fastener plate 42. In some cases, fastener plate 42 may be secured to the center pole 14 using a u-shaped bolt 40 and a pair of nuts 46 and 48. U-shaped bolt 40 may be disposed about the center pole 14 and disposed through two holes of fastener plate 42. Nuts 46 and 48 may be tightened on the two ends of the u-shaped bolt 40 to secure the fastener plate 42 to the center pole 14. In some cases, the angle of the center pole 14 relative to the base 12 may be adjusted by sliding the u-shaped bolt 40 or other connecting mechanism, such as for example a sleeve, along the center pole 14. In other cases, the u-shaped bolt 40 may be fixed relative to the center pole 14 providing a stationary angle of the center pole 14 relative to the base 12. In some cases, the upper ends of support rods 22 and 23 may have a reduced diameter section that may be configured to be received within corresponding openings of the connector plate 42. The openings of the connector plate 42 may be sized to pass the reduced diameter of support rods 22 and 23, but not the non-reduced diameter portion. It is contemplated that any other suitable method of connecting the support rods 22 and 23 to the center pole 14 may be used, as desired.

In the illustrative embodiment, an upper end of the center pole 14 may include an opening 20 configured to receive a portion of a tree connector (example shown as 60 in FIGS. 5 and 6). While the opening 20 is disposed at the upper end of the center pole 14, it is contemplated that the opening 20 or other connector may be disposed at any desired location along the length of the center pole 14, as desired.

FIG. 3 is a perspective view of the illustrative tree stand 10 of FIG. 1 in a collapsed state. As illustrated, the tree stand 10 shown in FIGS. 1 and 2 may be collapsible, but this is not required. In alternative embodiments, it is contemplated that the angles of the legs 11 and 13 and the center pole 14 may be fixed and non-collapsible, such as by welding or other methods of attachment, if desired.

To collapse the illustrative tree stand 10, support rods 22 and 23 may be removed from fastener plate 42 and/or sleeve and rotated to be longitudinally parallel to legs 11 and 13, respectively. In some cases, this may require the loosening of the other end of the support rods 22 and 23 attached to the legs 11 and 13. Additionally, fastener 38 securing an end of the support rod 24 to leg 11 may be removed and support rod 24 may be longitudinally parallel with leg 13. In some cases, fastener 38 may then be used to secure the end of support rod 24 to leg 13. Alternatively, fastener 39 may be removed from support rod 24 and leg 13 and connector rod 24 may be positioned to be longitudinally parallel with leg 11, if desired.

With the support rods 22, 23, and 24 moved, center pole 14 may be moved to a position in a plane with both legs 11 and 13. Also, the legs 11 and 13 may be moved together adjacent the center pole 14. In some cases, the inner pole member 16 may be slid within outer pole member 18 to decrease the overall length of the center pole 14, if desired.

FIG. 4 is a perspective view of the illustrative tree stand 10 of FIGS. 1 and 2 suspending a tree 50. As illustrated, a tree 50 may be connected to the upper end of stand 10 (e.g. opening 20), although it is contemplated that a tree 50 may be connected to a part that is proximal of the upper end of stand 10. In any event, the height of the center pole 14 may be adjusted so that the bottom of the tree trunk 72 of tree 50 may be raised slightly above a plane extending through both legs 11 and 13 of the base 12 of the stand 10. In other words, the center pole 14 may be adjusted so that the bottom of the tree trunk 72 is raised slightly off the ground, such as for example, about 1 inch, about 2 inches, about 3 inches, about 4 inches, about 5 inches, about 6 inches, about 1 foot, or any other distance off the ground, as desired. As such, the tree 50 may be suspended in a generally vertical and generally straight orientation relative to the ground.

In some cases, the stand 10 may be connected to the trunk 72 of the tree 50 at a point at or above the center of gravity of the tree 50. In such an attachment position, the weight of the tree 50 may help position the tree in a straight and upright orientation relative to the ground. Although the tree stand 10 is shown outside of the tree 50, it is contemplated that some of the branches of the tree 50 may extend around the stand 10, depending on the angle of the center pole 14 from the base 12.

FIG. 5 is a perspective view of an illustrative tree connector 60 configured to engage the opening 20 of the illustrative stand 10 of FIGS. 1 and 2. As illustrated, the tree connector 60 may include a hook portion 62 that may be received within tree stand opening 20. Tree connector 60 may include two arms 68 and 69 extending outward from a body of the tree connector 60, and may have a slight backward bend, but this is not required. In such a configuration, the arms may better engage the tree trunk 72, but this is not required. Also, arms 68 and 69 may each include an opening 64 and 66, respectively, configured to receive a strap for securing a tree to the tree connector 60.

While illustrative tree connector 60 has been shown and described, it is contemplated that any suitable connector may be used to connect the tree to tree stand 10, such as, for example, an s-shaped hook and strap, a strap connected directly to the stand 10, a connector that clamps around the tree trunk 72, or any other suitable connector as desired.

FIG. 6 is a perspective view of the tree connector 60 of FIG. 5 coupled to trunk 72 of the illustrative tree 50. As illustrated, the tree connector 60 may be positioned on a side of the trunk 72. Arms 68 and 69 may extend around a portion of the trunk 72 and strap 70, which is connected to the tree connector 60 through openings 64 and 66, may extend around the remainder of the trunk 72.

As illustrated, the hook portion 64 of the tree connector 60 may be configured to be received in opening 20 of the inner pole member 16 of the center pole 14. In some cases, with the tree connector 60 attached to the trunk 72 of the tree 50 above the center of gravity of the tree 50, the tree 50 may be lifted so that hook portion 64 is positioned within opening 20, or stand 10 may be tilted at an angle so that the opening 20 engages the hook portion 64 of the tree connector 60. Then, the tree stand may be moved to a position with the base 12 flat on the ground causing tree 50 to be lifted off and suspended above the ground.

FIG. 7 is a perspective view of the illustrative tree stand 10 of FIG. 1 suspending a tree 50, similar to FIG. 4, with a container 74 positioned around the lower end of the tree trunk. As illustrated, and to help provide water to a decorative tree, such as a Christmas tree, a container 74 may be positioned under the lower end of the trunk 72 of the tree 50, and may be configured to hold a liquid, such as water. In this configuration, the lower end of the trunk 72 may be exposed to the water to water the tree 50. In some cases, the container 74 may be easily removable by tilting the tree 50 on the stand 10.

While the foregoing disclosure has been described with reference to suspending a tree, it is contemplated that the stand 10 may be used for suspending other items, such as, for example, a workout heavy bag, a speed bag, a campfire pit grill, a flower pot, as well as any other suitable item, as desired.

Having thus described the preferred embodiments of the present invention, those of skill in the art will readily appreciate that yet other embodiments may be made and used within the scope of the claims hereto attached. Numerous advantages of the invention covered by this document have been set forth in the foregoing description. It will be understood, however, that this disclosure is, in many respect, only illustrative. Changes may be made in details, particularly in matters of shape, size, and arrangement of parts without exceeding the scope of the invention. The invention's scope is, of course, defined in the language in which the appended claims are expressed.

1. A tree stand comprising:
a base for providing stability for the tree stand, wherein the base includes a first leg and a second leg arranged in a generally v-shaped base configuration;
a center pole having a first end, a second end, and a length extending therebetween, wherein the first end of the center pole is coupled to the base and the second end is spaced a distance from the base defining an angle between the center pole and the base; and
wherein only the second end of the center pole of the tree stand is configured to be coupled to a tree and suspend the tree therefrom.

2. The tree stand of claim 1 further comprising a tree connector configured to be attached to a tree and coupled to the center pole at or adjacent the second end of the center pole.

3. The tree stand of claim 2 wherein the tree connector includes a pair of arms configured to receive a strap to secure to the tree relative to the tree connector, the tree connector including a hook portion configured to engage the second end of the center pole.

4. The tree stand of claim 2 wherein the tree connector is configured to be attached to the tree at a location at or above the center of gravity of the tree.

5. The tree stand of claim 1 wherein the tree is configured to be suspended from the tree stand so that the bottom of the tree is suspended above the base.

6. The tree stand of claim 1 wherein the center pole is extendable.

7. The tree stand of claim 6 wherein the center pole includes an inner pole member and an outer pole member configured to receive the inner pole member, wherein the center pole has a locked state and a moveable state, when in the locked state, the inner pole member is fixed relative to the outer pole member and, in the moveable state, the inner pole member is moveable relative to the outer pole member.

8. The tree stand of claim 7 wherein the outer pole member is coupled to the base and the inner pole member is configured to be coupled to the tree.

9. The tree stand of claim 1 wherein the tree stand is collapsible.

10. (canceled)

11. The tree stand of claim 1 further comprising a container configured to be positioned about a portion of a lower end of the tree, wherein the container is configured to hold a liquid.

12. The tree stand of claim 1, wherein the angle between the center pole and the base is between 45 and 90 degrees.

13. A method for displaying a decorative tree, the method comprising:
providing a tree stand including a base and a center pole, the center pole having a first end coupled to the base and a second end disposed at a height above the base; and
suspending the decorative tree from the second end of the center pole.

14. The method of claim 13 wherein the coupling the decorative tree to the second end of the center pole comprises:
attaching a tree connector to a portion of a trunk of the decorative tree above the center of gravity of the decorative tree; and
connecting the tree connector to the second end of the center pole.

15. The method of claim 13 further comprising adjusting a length of the center pole according to a height of the decorative tree such that the decorative tree does not rest on the base.

16. A tree stand comprising:
a base for providing stability to the stand, the base including a first leg and a second leg, wherein a first end of the first leg is coupled to a first end of the second leg to form a generally v-shaped base configuration;
a center pole including an inner member and an outer member, wherein a first end of the outer member is coupled to the first end of the first leg and to the first end of the second leg, wherein the second end of the outer member is configured to receive a first end of the inner member, wherein the second end of the inner member is configured to be coupled to a tree;
a first support member extending between the center pole and the first leg of the base; and
a second support member extending between the center pole and the second leg of the base, wherein the first and second support members provide support for suspending the tree from the second end of the center pole.

17. The tree stand of claim 16 further comprising a tree connector configured to be secured to a tree, the tree connector including a hook configured to engage the second end of the inner pole member.

18. The tree stand of claim 17 further comprising a tree secured to the tree connector, wherein the tree is suspended when the hook engages the second end of the inner pole member.

19. The tree stand of claim 18 further comprising a container positioned about a portion of a trunk of the tree, the container configured to hold a liquid.

20. The tree stand of claim 16 wherein the inner pole member is configured to be moveable relative to the outer pole member to adjust the length of the center pole.
